(19) United States
(12) Patent Application Publication
(10) Pub. No.: US 2019/0195415 A1
(43) Pub. Date: Jun. 27, 2019

(54) Protective Brace for Conduit

(71) Applicant: David Wayne Kliewer, Enid, OK (US)

(72) Inventor: David Wayne Kliewer, Enid, OK (US)

(21) Appl. No.: 16/232,850

(22) Filed: Dec. 26, 2018

Related U.S. Application Data
(60) Provisional application No. 62/610,357, filed on Dec. 26, 2017.

(51) Int. Cl. F16L 57/06

(52) U.S. Cl. CPC F16L 57/06

(57) ABSTRACT

A protective brace for conduit is used to retain a section of conduit in a desired configuration while preventing the section of conduit from becoming kinked. To accomplish this, the protective brace has a pair of u-shaped braces and a collection of detachable fasteners. The two u-shaped braces can be clamped around the section of conduit and then held together by the collection of detachable fasteners. Specifically, the collection of detachable fasteners is connected along the lengthwise edges of the pair of u-shaped braces. Accordingly, the u-shaped braces form a rigid tubular brace that is placed around the section of conduit. Preferably, the two u-shaped braces are designed to retain the section of conduit in a curved configuration.

The current application claims a priority to the U.S. Provisional Patent application Ser. No. 62/610,357 filed on Dec. 26, 2017.

### FIELD OF THE INVENTION

The present invention generally relates to protective equipment. More specifically the present invention is a protective cast designed to prevent kinks in flexible pipes, hoses, or conduit.

### BACKGROUND OF THE INVENTION

Tubular piping is used in a plurality of fields most commonly construction. Infrastructure projects can be costly, and safety is one of the critical factors, therefore conducting these processes with accuracy is of high importance. In addition, due to budget constraints, construction equipment alternation may further jeopardize the safety of the personnel. The necessity to distribute water over areas where it was inaccessible led to development of complex networks of tubular structures. Transporting fluids over great distances is at the basis of modern lifestyle. A household is a prime example where plumbing and pipe network systems are frequently used. A plurality of piping structures is used depending on the task. Conduit of various sizes is used to house electrical systems as well. In addition, resources such as natural gas and oil are transported using piping of various sizes.

Construction methods have improved significantly over the years, resulting in more efficient structures, lower costs, and a safer working environment. Modern technology led to the development of better methods of transporting liquids and even gasses over lengthy distances. Transfer lines are used at worksites to transfer large quantities of liquids over various distances such as water or fuel. Supplying liquids from a single source at multiple points in a work area, requires angled attachments. Workers are required to cut existing conduit and install angled adapters, a process which may take long periods of time, increase equipment cost and jeopardize safety.

### BRIEF DESCRIPTION OF THE DRAWINGS

FIG. 1 is a front perspective view of the present invention.

FIG. 2 is a rear perspective view of the present invention.

FIG. 3 is a top view of the first u-shaped brace used in the present invention.

FIG. 4 is a top view of the second u-shaped brace used in the present invention.

FIG. 5 is a cross-sectional profile view of the present invention showing the first u-shaped brace and the second u-shaped brace.

### DETAIL DESCRIPTIONS OF THE INVENTION

All illustrations of the drawings are for the purpose of describing selected versions of the present invention and are not intended to limit the scope of the present invention.

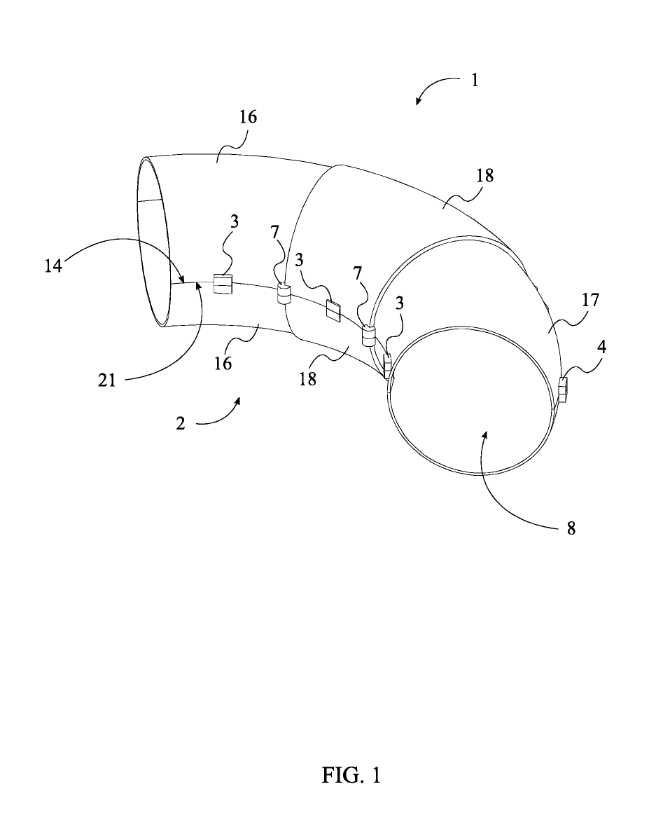

Referring to FIG. 1 through FIG. 5, the present invention, a protective brace for conduit, is a device that enables a flexible hose or conduit to be redirected without becoming kinked or obstructed. The present invention makes use of a rigid brace that can be clamped around a section of the flexible conduit. This rigid brace retains the flexible conduit in a desired shape until removed. Specifically, the present invention comprises a first u-shaped brace 1, a second u-shaped brace 2, a first plurality of detachable fasteners 3, a second plurality of detachable fasteners 4, and a conduit channel 5. The first u-shaped brace 1 is designed to be a mirrored version of the second u-shaped brace 2 such that the two components can be mated to form a brace that circumscribes the conduit. Specifically, the first plurality of detachable fasteners 3 is connected in between a first lateral edge 14 of the first u-shaped brace 1 and a first lateral edge 21 of the second u-shaped brace 2. Additionally, the second plurality of detachable fasteners 4 is connected in between a second lateral edge 15 of the first u-shaped brace 1 and a second lateral edge 22 of the second u-shaped brace 2. As a result, the first u-shaped brace 1 and the second u-shaped brace 2 form an elongated member that can be placed around a section of conduit. Further, the conduit channel 5 is delineated by the first u-shaped brace 1 and the second u-shape brace while the two components are coupled by the first plurality of detachable fasteners 3 and the second plurality of detachable fasteners 4. Preferably, the first u-shaped brace 1 and the second u-shaped are each semicircular in cross-sectional profile. Accordingly, the present invention can be deployed to redirect pieces of conduit that have been previously installed. To achieve this functionality, a user placed the conduit into in between the first lateral edge 14 of the first u-shaped brace 1 and the second lateral edge 15 of the first u-shaped brace 1. The user then couples the second u-shaped brace 2 to the first u-shaped brace 1 by engaging the first plurality of detachable fasteners 3 and the second plurality of detachable fasteners 4. The first u-shaped brace 1 is mated to the second u-shaped brace 2 with fasteners including, but not limited to, clasps, screws, clamps, magnetic couplers, and interlocking members.

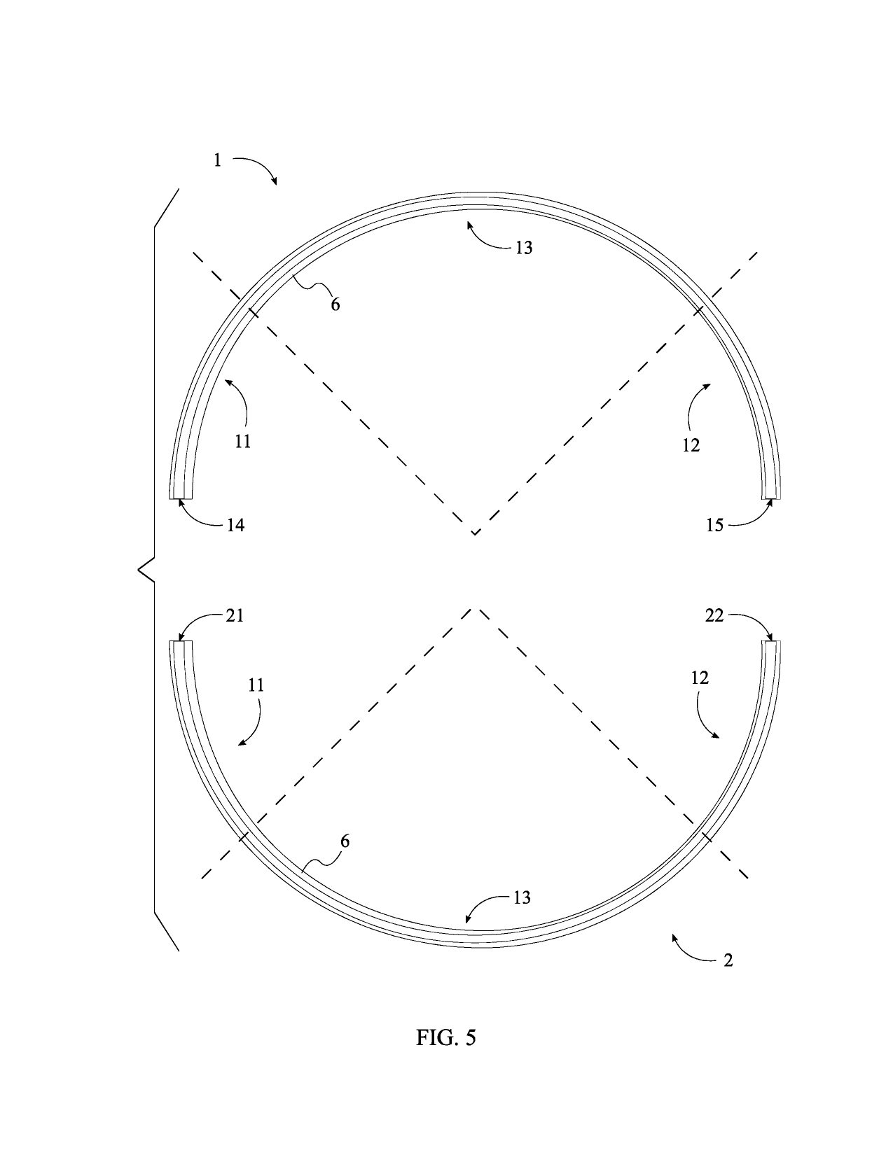

Referring to FIG. 1 and FIG. 5, as described above, the present invention is designed to function as a tubular housing that is placed around the section of conduit. The conduit channel 5 longitudinally traverses through the tubular housing created by the first u-shaped brace 1 and the second u-shaped brace 2 and acting as a protective enclosure for the section of conduit. The first u-shaped brace 1 and the second u-shaped brace 2 each comprise a first leg 11, a second leg 12, and an intermediary webbing 13. The intermediary webbing 13 is a rigid section of each brace that is connected in between the first leg 11 and the second leg 12. Consequently, the intermediary webbing 13 forms the interconnecting portion of the u-shaped brace that cradles the conduit.

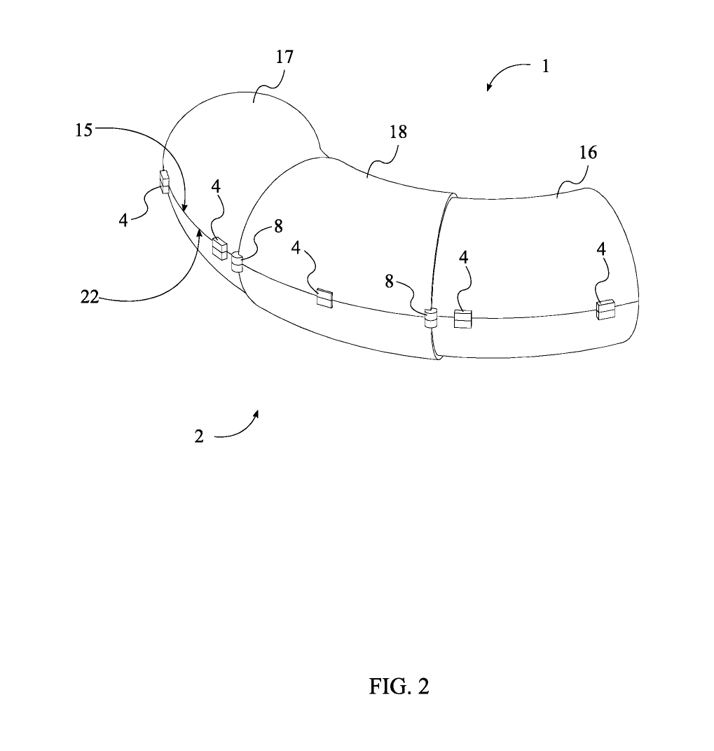

Referring to FIG. 1, FIG. 2, and FIG. 5, the first lateral edge of the first u-shaped is being positioned adjacent to the first leg 11 of the first u-shaped brace 1, opposite to the intermediary webbing 13 of the first u-shaped brace 1. Additionally, the second lateral edge 15 of the first u-shaped brace 1 is positioned adjacent to the second leg 12 of the first u-shaped brace 1, opposite to the intermediary webbing 13 of the first u-shaped brace 1. Thus, the first u-shaped brace 1 forms a trough for the conduit that can be mated to the second u-shaped brace. Similarly, the first lateral edge 21 of the second u-shaped brace is positioned adjacent to the first leg 11 of the second u-shaped brace, opposite to the intermediary webbing 13 of the second u-shaped brace. Further, the second lateral edge 22 of the second u-shaped brace is positioned adjacent to the second leg 12 of the second u-shaped brace, opposite to the intermediary webbing 13 of the second u-shaped brace. Accordingly, the second u-shaped brace forms a mirror image of the first u-shaped brace 1. The first plurality of detachable fasteners 3 is connected in between the first leg 11 of the first u-shaped brace 1 and the first leg 11 of the second u-shaped brace 2. Likewise, the second plurality of detachable fasteners 4 is connected in between the second leg 12 of the first u-shaped brace 1 and the second leg 12 of the second u-shaped brace 2. As a result, the first plurality of detachable fasteners 3 and the second plurality of detachable fasteners 4 to couple the first u-shaped brace 1 to the second u-shaped brace 2, around the section of conduit.

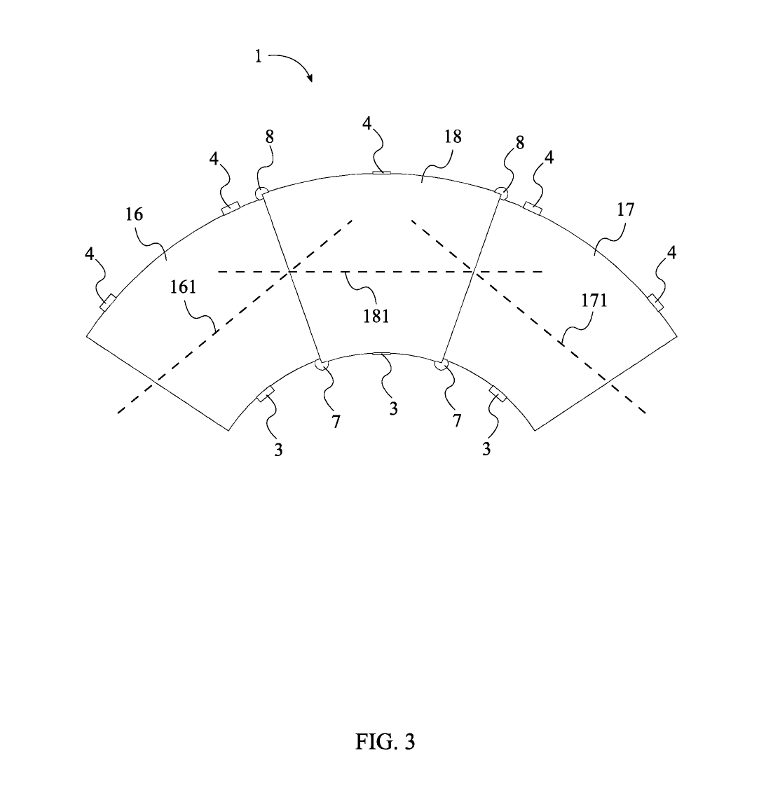

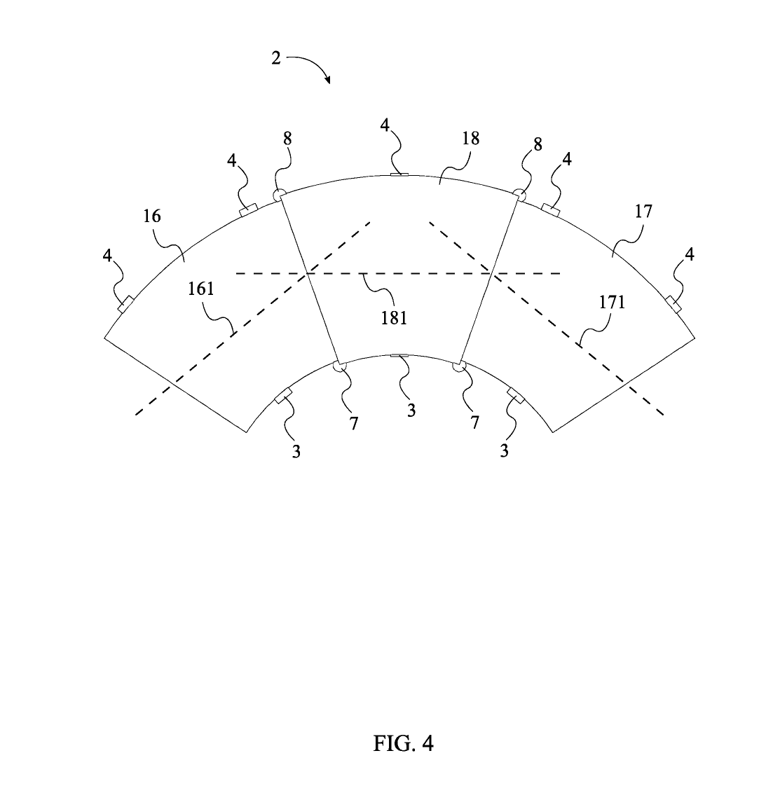

Referring to FIG. 3, FIG. 4, and FIG. 5, the present invention is designed as a brace that redirects the section of conduit while preventing kinks. To achieve this, the first u-shaped brace 1 and the second u-shaped brace 2 each comprise a first directional-adjustment portion 16, a second directional-adjustment portion 17, and a central portion 18. The first directional-adjustment portion 16, the second, directional-adjustment portion, and the central portion 18 enable the present invention to form one or more bends in the section of conduit. Specifically, the first directional-adjustment portion 16 is terminally connected to the central portion 18. Additionally, an orientation axis 161 of the first directional-adjustment portion 16 is angularly offset from an orientation axis 181 of the central portion 18. As a result, the section of conduit is retained in a bent configuration that corresponds to the angular offset between the orientation axis 161 of the first directional-adjustment portion 16 and the orientation axis 181 of the central portion 18. Similarly, the second directional-adjustment portion 17 is terminally connected to the central portion 18, opposite to the first directional-adjustment portion 16. Likewise, an orientation axis 171 of the second directional-adjustment portion 17 is angularly offset from the orientation axis 181 of the central portion 18, Accordingly, the second directional-adjustment portion 17 retains the section of conduit in an orientation that is angularly offset from the central portion 18. Preferably, the first directional-adjustment portion 16 and the second directional-adjustment portion 17 are configured to transition the section of conduit through a ninety-degree turn. Additionally, multiple sections of the present invention may be linked to form a serpentine route for the section of conduit.

Referring to FIG. 1, FIG. 2, and FIG. 5, the present invention is designed to function as a multifaceted system that can be used to retrofit the section of conduit. To that end, the present invention further comprises a protective coating 6, at least one first locking mechanism 7, and at least one second locking mechanism 8. The protective coating 6 is superimposed onto the first u-shaped brace 1 and the second u-shaped brace 2. As a result, the protective coating 6 modifies the material properties of the first u-shaped brace 1 and the second u-shaped brace 2. For example, the first u-shaped brace 1 and the second u-shaped brace 2 will be coated in a thermally insulating protective coating 6 when the section of conduit must be shielded from high temperatures in the external environment. Embodiments of the resent invention are equipped with protective coating 6s that serve various functions including, but not limited to, electromagnetic insulation, lubrication, and corrosion resistance. The first locking mechanism 7 is connected in between the first lateral edge 14 of the first u-shaped brace 1 and the first lateral edge 21 of the second u-shaped brace 2. Similarly, the second locking mechanism 8 is connected in between the second lateral edge 15 of the first u-shaped brace 1 and the second lateral edge 22 of the second u-shaped brace 2. Consequently, the first u-shaped brace 1 cannot become decoupled from the second u-shaped brace 2 without first disengaging the first locking mechanism 7 and the second locking mechanism 8.

Although the invention has been explained in relation to its preferred embodiment, it is to be understood that many other possible modifications and variations can be made without departing from the spirit and scope of the invention as hereinafter claimed.

What is claimed is:

1. A protective brace for conduit comprising:
a first u-shaped brace;
a second u-shaped brace;
a first plurality of detachable fasteners;
a second plurality of detachable fasteners;
a conduit channel;
the first plurality of detachable fasteners being connected in between a first lateral edge of the first u-shaped brace and a first lateral edge of the second u-shaped brace;
the second plurality of detachable fasteners being connected in between a second lateral edge of the first u-shaped brace and a second lateral edge of the second u-shaped brace; and
the conduit channel being delineated by the first u-shaped brace and the second u-shape brace.

2. The protective brace for conduit as claimed in claim 1 comprising:
the first u-shaped brace and the second u-shaped brace each comprising a first leg, a second leg, and an intermediary webbing; and
the intermediary webbing being connected in between the first leg and the second leg.

3. The protective brace for conduit as claimed in claim 2 comprising:
the first lateral edge of the first u-shaped brace being positioned adjacent to the first leg of the first u-shaped brace, opposite to the intermediary webbing of the first u-shaped brace; and
the second lateral edge of the first u-shaped brace being positioned adjacent to the second leg of the first u-shaped brace, opposite to the intermediary webbing of the first u-shaped brace.

4. The protective brace for conduit as claimed in claim 2 comprising:
the first lateral edge of the second u-shaped brace being positioned adjacent to the first leg of the second u-shaped brace, opposite to the intermediary webbing of the second u-shaped brace; and
the second lateral edge of the second u-shaped brace being positioned adjacent to the second leg of the second u-shaped brace, opposite to the intermediary webbing of the second u-shaped brace.

5. The protective brace for conduit as claimed in claim 2 comprising:
the first plurality of detachable fasteners being connected in between the first leg of the first u-shaped brace and the first leg of the second u-shaped brace; and
the second plurality of detachable fasteners being connected in between the second leg of the first u-shaped brace and the second leg of the second u-shaped brace.

6. The protective brace for conduit as claimed in claim 1 comprising:
the first u-shaped brace and the second u-shaped brace each comprising a first directional-adjustment portion, a second directional-adjustment portion, and a central portion;
the first directional-adjustment portion being terminally connected to the central portion;
an orientation axis of the first directional-adjustment portion being angularly offset from an orientation axis of the central portion;
the second directional-adjustment portion being terminally connected to the central portion, opposite to the first directional-adjustment portion; and
an orientation axis of the second directional-adjustment portion being angularly offset from the orientation axis of the central portion.

7. The protective brace for conduit as claimed in claim 1 comprising:
a protective coating; and
the protective coating being superimposed onto the first u-shaped brace and the second u-shaped brace.

8. The protective brace for conduit as claimed in claim 1 comprising:
at least one first locking mechanism; and
the first locking mechanism being connected in between the first lateral edge of the first u-shaped brace and the first lateral edge of the second u-shaped brace.

9. The protective brace for conduit as claimed in claim 1 comprising:
at least one second locking mechanism; and
the second locking mechanism being connected in between the second lateral edge of the first u-shaped brace and the second lateral edge of the second u-shaped brace.

10. The protective brace for conduit as claimed in claim 1, wherein the first u-shaped brace and the second u-shaped brace each being semicircular in cross-sectional profile.
